(19) United States
(12) Patent Application Publication
(10) Pub. No.: US 2026/0049519 A1
(43) Pub. Date: Feb. 19, 2026

(54) DOOR/WINDOW FIXTURE

(71) Applicant: PROFILATI S.P.A. Unipersonale, Bologna (IT)

(72) Inventor: Marco GALLIANI, Bologna (IT)

(73) Assignee: PROFILATI S.P.A. Unipersonale, Bologna (IT)

(21) Appl. No.: 19/298,120

(22) Filed: Aug. 12, 2025

(30) Foreign Application Priority Data
Aug. 13, 2024 (IT) 102024000018976
Nov. 12, 2024 (IT) 102024000025515
Jul. 8, 2025 (IT) 102025000016894

(51) Int. Cl. E06B 3/26; E06B 3/32; E06B 3/96

(52) U.S. Cl. CPC E06B 3/26; E06B 3/32; E06B 3/9608

(57) ABSTRACT

A fixture for a door or window includes a fixed frame and a movable frame. At least one of the fixed frame or the movable frame includes a first metal profile made of aluminum or aluminum alloy, a second metal profile also made of aluminum or aluminum alloy, and at least one laser joint between the first profile and the second profile. A mechanical joint may also be provided between the first profile and the second profile. The mechanical joint including a metal bracket made of aluminum or aluminum alloy.

### CROSS-REFERENCE TO RELATED APPLICATIONS

This application claims benefit of priority to Italian Patent Application No. 102024000018976 filed Aug. 13, 2024, Italian Patent Application No. 102024000025515, filed Nov. 12, 2024, and Italian Patent Application No. 102025000016894 filed on Jul. 8, 2025. The entire contents of which are hereby incorporated by reference.

### FIELD

The present invention relates to a door/window fixture of the type comprising a fixed frame and a movable frame, which includes one or more openable sashes.

### BACKGROUND

In some door/window fixture of this type, both the fixed frame and the movable frame include an inner frame and an outer frame made of aluminum or its alloys, possibly separated by an insulating material to thermally isolate the interior of the door/window fixture from the exterior.

Each of the four frames (inner fixed, outer fixed, inner movable, and outer movable) comprises four metal profiles, generally aluminum or aluminum alloy profiles, mechanically connected at their ends using dedicated brackets to form a quadrangular frame.

The profiles may have ends cut at 45° or 90°, creating clearly visible joint lines that significantly affect the product's aesthetic appearance.

It is known that the mechanical connection between the profiles may weaken over time, due both to the weight of the door/window fixture and to repeated opening and closing operations. A typical consequence is the loss of the initial geometric shape of the door/window fixture, which may become deformed, sometimes imperceptibly, making proper opening and closing more difficult.

As a result, opening and closing the door/window fixture becomes more laborious and less smooth compared to when the door/window fixture is new, since the movable frame no longer perfectly mates with the fixed frame; additionally, any forcing during opening or closing the door/window fixture can damage its aesthetic finish.

The technical aim of the present invention is therefore to provide a door/window fixture that eliminates the technical drawbacks of the known art.

Within this technical aim, one object of the invention is to create a metal door/window fixture, particularly in aluminum or its alloys, that is extremely robust while also offering excellent aesthetic quality.

This technical aim, as well as the above and other objects, according to one aspect of the invention, are achieved by a door/window fixture comprising a fixed frame and a movable frame, wherein at least one of the fixed or movable frames includes at least one mechanical joint between a first profile and a second profile, wherein the mechanical joint includes a joining bracket, characterized in that it comprises a first additional laser-welded joint between the first and second profiles and/or a second additional laser-welded joint between at least one of said first and second profiles and the bracket, and in that said first profile, said second profile, and said joining bracket are made of the same material, selected from aluminum or an aluminum alloy.

Advantageously, using the same material allows the laser welding process to melt the bracket and both profiles uniformly, without differences in melting or cooling behaviour.

This technical aim, as well as the above and other objectives, are further achieved, according to another aspect of the invention, by producing a thermal break door/window fixture comprising a fixed frame and a movable frame, wherein the fixed frame includes a metallic inner fixed frame made of inner fixed frame profiles connected by a first set of corner joints, and an outer fixed frame made of outer fixed frame profiles connected by a second set of corner joints; wherein the movable frame includes a metallic inner movable frame made of inner movable frame profiles connected by a third set of corner joints, and an outer movable frame made of outer movable frame profiles connected by a fourth set of corner joints; characterized in that each corner joint in the first, second, third, and fourth sets includes at least one laser-welded joint between thickened walls of the metallic profiles of the fixed and movable frames, which extend orthogonally to the visible walls of the said metallic profiles of the fixed frame and the movable frame, said thickened walls have a minimum thickness between 2 and 3 times greater than the minimum thickness of the visible walls of the metallic profiles of the fixed frame and the movable frame.

### BRIEF DESCRIPTION OF THE DRAWINGS

Additional features and advantages of the invention will become more apparent from the description of several preferred, but not exclusive, embodiments of the frame according to the invention, illustrated by way of example but not limitation in the attached drawings, in which:

FIG. 1 shows a first embodiment of the invention, and in particular an outer corner of a door/window fixture before the execution of the first additional laser-welded joint;

FIG. 2 shows the corner of the door/window fixture of FIG. 1, still from the outer side, after the execution of the first additional laser-welded joint;

FIG. 3 shows the corner of the door/window fixture of FIG. 1 from the inner side, before the execution of the first additional laser-welded joint;

FIG. 4 shows the corner of the door/window fixture of FIG. 1 from the inner side, after the execution of the first additional laser-welded joint.

FIG. 5 shows a section of the door/window fixture at the joining brackets; in particular, four joining brackets are shown, two of which feature the second additional laser weld joint along the peripheral edges, and two with the second additional laser weld joint positioned set back from the peripheral edges.

At the two brackets with the second additional laser weld joint along the peripheral edges, two possible alternative welds are also shown with dashed lines: in fact, it is possible to perform these two welds either along the peripheral edges or in a position set back from the peripheral edges. Two additional brackets and their corresponding possible welds, which can be used as alternatives to the brackets already shown, are also illustrated with dashed lines.

FIG. 6 shows an exploded view of a corner of the fixed frame where four profiles of the same fixed frame are joined.

FIG. 7 shows a perspective view of the corner of the fixed frame from FIG. 6, with the second additional laser weld joints along the peripheral edges of the brackets.

FIG. 8 shows a perspective view of the corner of the fixed frame from FIG. 6, with the second additional laser weld joints positioned set back from the peripheral edges of the brackets.

FIG. 9 shows the corner of the fixed frame from FIG. 8 from a different perspective view, with the horizontal side of the fixed frame corner partially sectioned and partially shown in transparency together with the vertical side, in order to reveal certain internal details.

FIG. 10 shows an exploded view of a corner of the movable frame where four profiles of the same movable frame are joined.

FIG. 11 shows a perspective view of the corner of the movable frame from FIG. 10, with the second additional laser weld joint of the upper bracket positioned set back from the peripheral edges, and the second additional laser weld joint of the lower bracket along the peripheral edges.

FIG. 12 shows a perspective view of the corner of the movable frame from FIG. 10, with the second additional laser weld joints positioned set back from the peripheral edges of the brackets.

FIG. 13 shows an exploded view of a corner of the movable frame where four profiles of the same movable frame are joined; the difference with respect to FIG. 10 lies in the lower bracket, which has a different shape and is positioned in a different groove.

FIG. 14 shows a perspective view of the corner of the movable frame from FIG. 13, with the second additional laser weld joints positioned set back from the peripheral edges of the brackets.

FIG. 15 shows an outer corner of a minimalist door/window fixture according to another embodiment;

FIG. 16 shows the inner corner of the minimalist door/window fixture in FIG. 15;

FIG. 17 shows a cross-section of the minimalist door/window fixture from FIGS. 15 and 16;

FIG. 18 shows a cross-section of a non-minimalist door/window fixture in accordance with yet another embodiment of the invention.

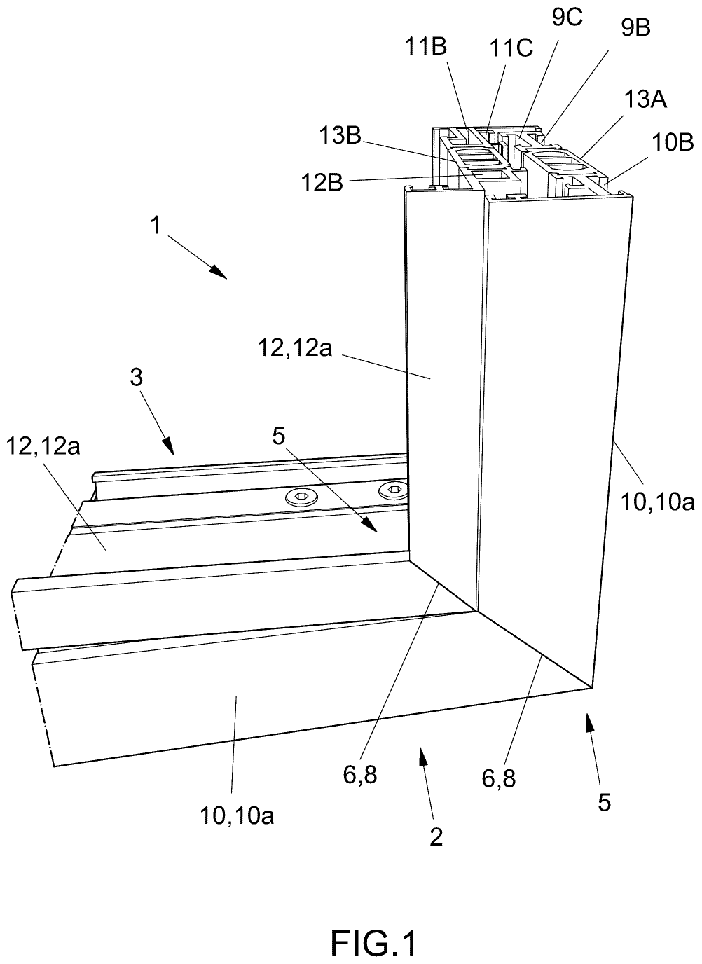

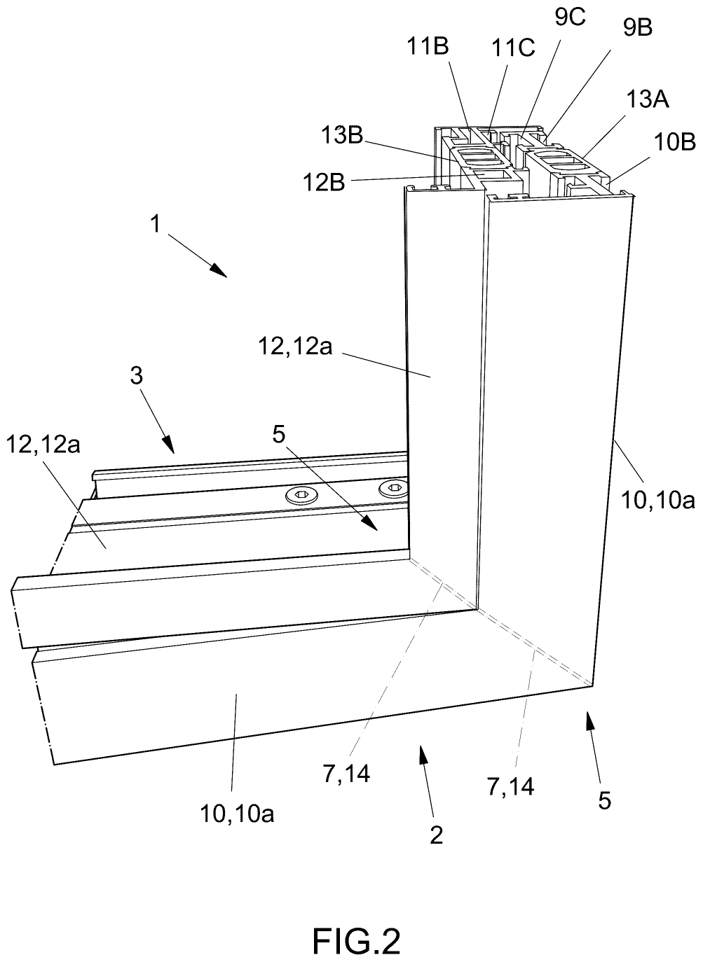

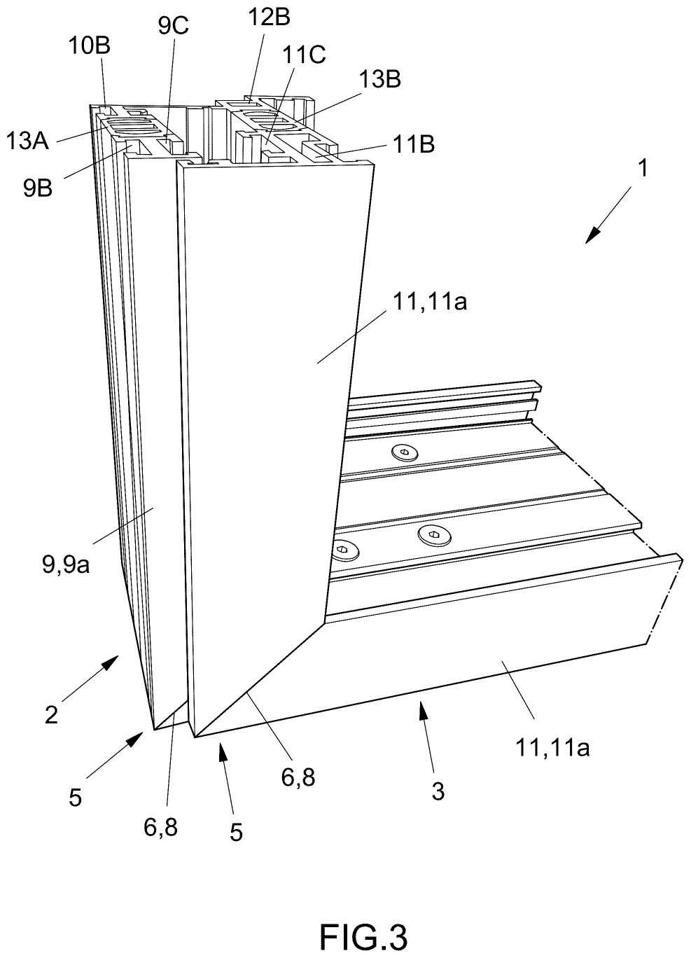

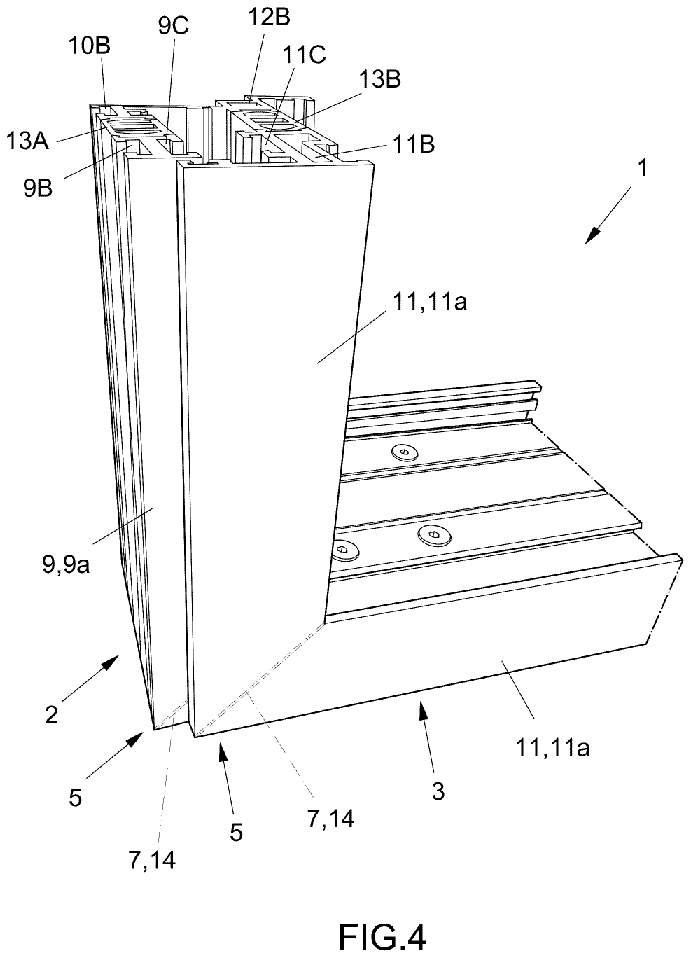

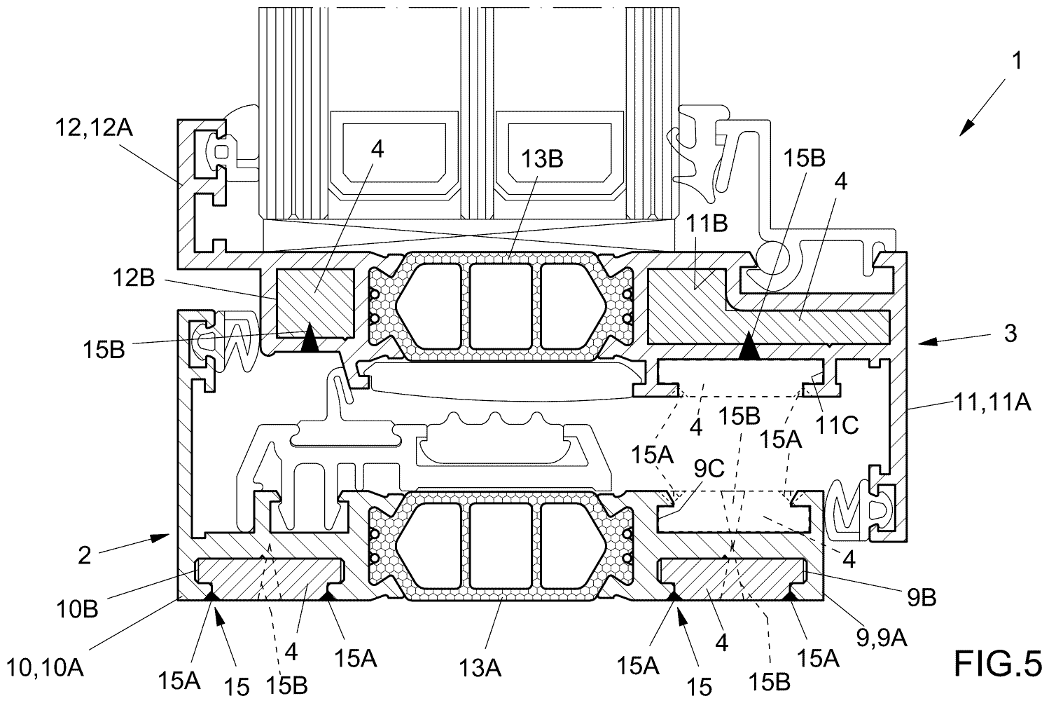

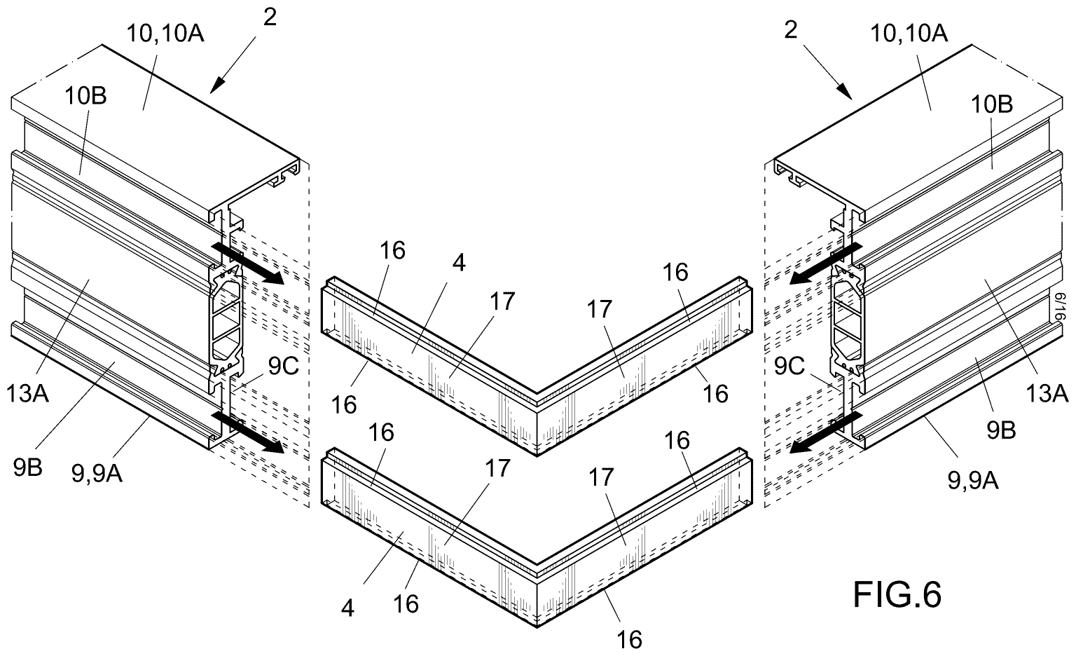

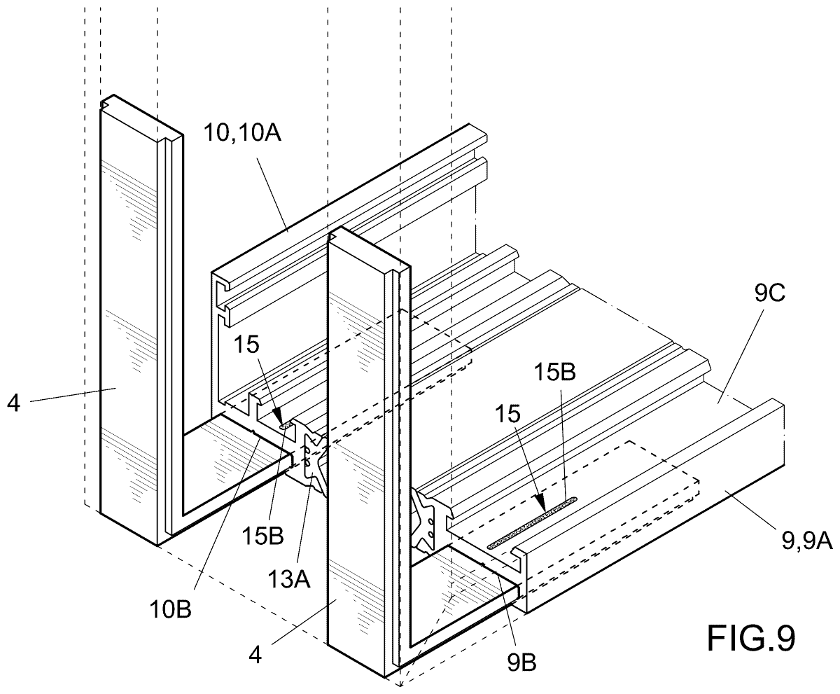

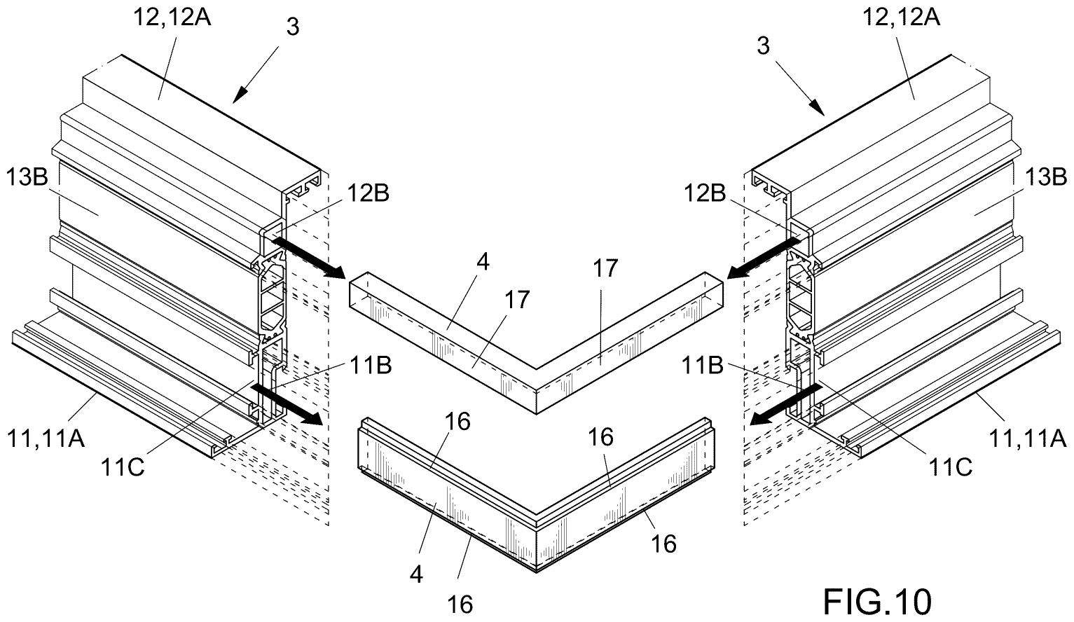

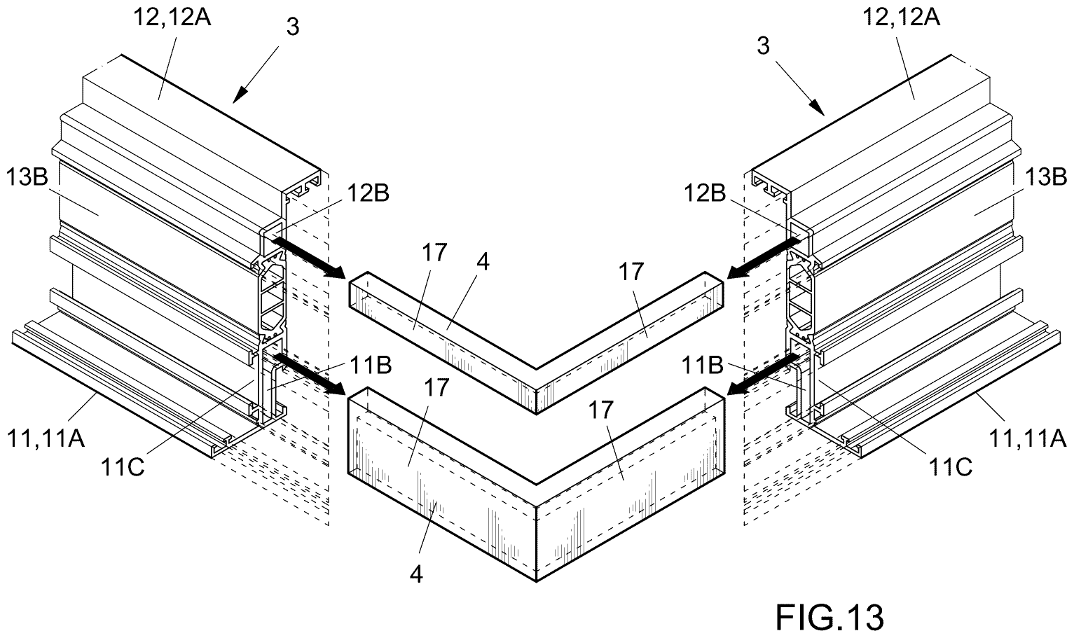

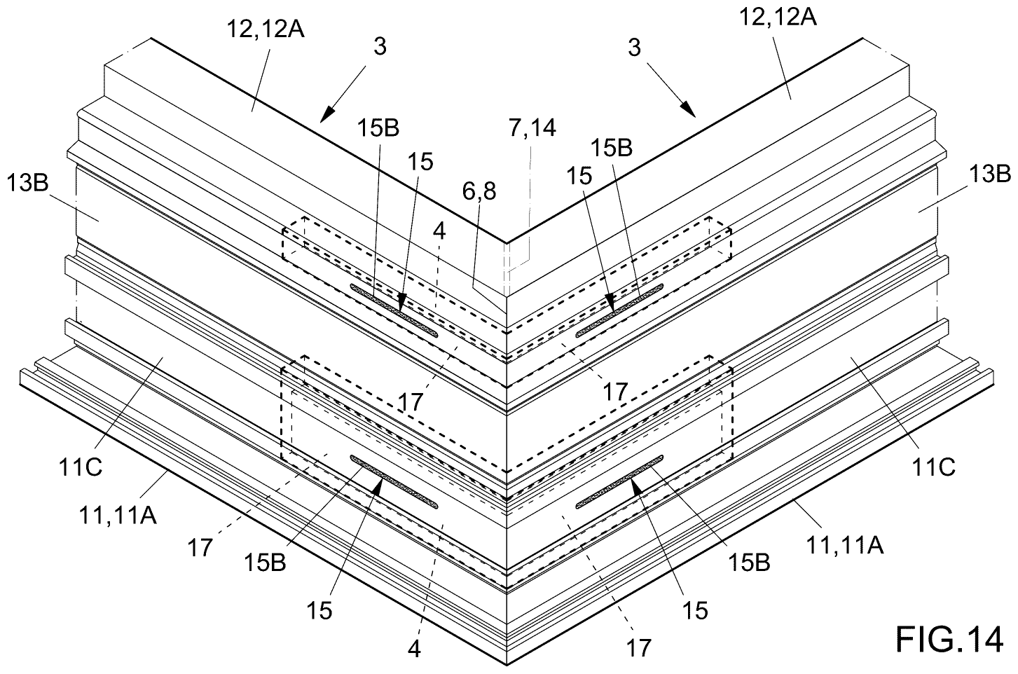

Referring to FIGS. 1-14, a corner of a door/window fixture, generally indicated with reference number 1, is shown.

### DETAILED DESCRIPTION

The frame 1 includes a fixed frame 2 and a movable frame 3.

The fixed frame 2 is formed by a series of profiles 9a, 10a and a series of mechanical joints 5 that connect adjacent profiles 9a, 10a to form a perimeter frame enclosing a seat for the movable frame 3.

Likewise, the movable frame 3, with one or more sashes, is formed by a series of profiles 11a, 12a and mechanical joints 5 that connect adjacent profiles 11a, 12a to form one or more frames that define one or more compartments for an infill panel, typically but not necessarily glass.

Preferably, all profiles 9a, 10a of the fixed frame 2 and all profiles 11a, 12a of the movable frame 3 are made of aluminum or aluminum alloy.

Specifically, the aluminum alloy used for the profiles 9a, 10a, 11a, and 12a is an alloy of aluminum, silicon, and magnesium.

Even more specifically, the profiles 9a, 10a, 11a, and 12a are made from aluminum alloy 6005 or 6060.

Preferably, the fixed frame 2 comprises an inner fixed frame 9, formed by profiles 9a connected in succession by mechanical joints 5, and an outer fixed frame 10, formed by profiles 10a connected in succession by mechanical joints 5, and the movable frame 3 comprises an inner movable frame 11, formed by profiles 11a connected in succession by mechanical joints 5, and an outer movable frame 12, formed by profiles 12a connected in succession by mechanical joints 5.

Preferably, the fixed frame 2 includes a thermal break that separates the inner fixed frame 9 from the outer fixed frame 10, and the movable frame 3 includes a thermal break that separates the inner movable frame 11 from the outer movable frame 12.

The thermal break in the fixed frame 2 is formed by a non-metallic, thermally insulating profile 13A, and the thermal break in the movable frame 3 is formed by a non-metallic, thermally insulating profile 13B.

Preferably, each frame 9, 10, 11, 12 is made of a quadrangular frame of four profiles 9a, 10a, 11a, 12a, two of which are horizontal and two vertical, joined at 90° to the horizontal profiles.

At each of its four corners, each frame 9, 10, 11, 12 thus includes a mechanical joint 5 between a first profile 9a, 10a, 11a, 12a and a second profile 9a, 10a, 11a, 12a adjacent to the first profile 9a, 10a, 11a, 12a.

The mechanical joint 5 is typically a butt joint between two flat ends cut at 45° of the adjacent profiles 9a, 10a, 11a, 12a.

The mechanical joint 5 typically includes at least one joining bracket 4, inserted and secured into internal grooves of the two adjacent profiles 9a, 10a, 11a, 12a.

The bracket 4 is also made of aluminum or aluminum alloy.

Specifically, the aluminum alloy of the bracket 4 is an alloy of aluminum, silicon, and magnesium.

More specifically, the bracket 4 is made from aluminum alloy 6005 or 6060.

Even more precisely, the first profile 9a, 10a, 11a, 12a, second profile 9a, 10a, 11a, 12a, and the bracket 4 are made of the same aluminum alloy.

The mechanical joint 5 between the first and second profiles 9a, 10a, 11a, 12a of the frame 9, 10, 11, 12 defines an interface surface 6 with a perimeter 8.

The first profile 9a, 10a, 11a, 12a and the second profile 9a, 10a, 11a, 12° of the frame 9, 10, 11, 12 are thus in direct contact through the interface surface 6.

The perimeter 8 of the interface surface 6 is visible at least along the portion located on the inner face of the door/window fixture 1 and along the portion located on the outer face of the door/window fixture 1.

Advantageously, in at least one mechanical joint 5, and preferably in all mechanical joints 5, there is a first additional laser-welded joint 14 between the first and second profiles 9a, 10a, 11a, 12a and/or a second additional laser-welded joint 15 between at least one of the first profile 9a, 10a, 11a, 12a and the second profile 9a, 10a, 11a, 12a and the joining bracket 4.

Preferably, both the first and the second additional laser-welded joints 14, 15 are present simultaneously, although the presence of only the first or only the second is not excluded.

Neither the first nor the second additional laser-welded joint 14, 15 involves the addition of filler material; in fact, these joints directly melt the bracket 4 and the first and second profiles 9a, 10a, 11a, 12a.

For this reason, it is essential that the bracket 4 and the two profiles 9a, 10a, 11a, 12a be made of the exact same material; in the second additional laser-welded joint 15, it is critical that the weld melt the bracket 4 and the first and second profiles 9a, 10a, 11a, 12a in the same way, without differences in fusion or cooling, possible only if the materials are identical.

The first additional laser-welded joint 14 includes a laser weld line 7 between the mechanically joined first and second profiles 9a, 10a, 11a, 12a.

The laser weld line 7 extends along at least a portion of the perimeter 8 of the interface surface 6.

In particular, at least one portion of the perimeter 8 of the interface surface 6 is a visible portion.

More precisely, the laser weld line 7 extends at least along the visible section of the inner face of the door/window fixture 1, and preferably also along the visible section of the outer face of door/window fixture 1.

It is not excluded that the weld line 7 could extend along the entire perimeter 8 of the interface surface 6.

Because no filler material is added, there is a clear aesthetic advantage, especially for the first additional laser-welded joint 14: indeed, after welding the two adjacent profiles 9a, 10a, 11a, 12a, the welded portions of the perimeter 8 are no longer visible, since, if the welding is properly performed, the material of the two profiles 9a, 10a, 11a, 12a melts and the resulting surface appears homogeneous.

The second additional laser-welded joint 15 between at least one of the first and second profiles 9a, 10a, 11a, 12a and the bracket 4 is preferably provided in duplicate; in fact, it is provided both between the first profile 9a, 10a, 11a, 12a and the bracket 4, and between the second profile 9a, 10a, 11a, 12a and the bracket 4.

The second additional laser-welded joint 15 includes laser weld lines 15A extending along one or more perimeter edges 16 of the bracket 4.

Alternatively, or additionally, the second additional laser-welded joint 15 includes laser weld lines 15B positioned recessed 17 from the perimeter edges 16 of the bracket, extending through part or all of the thickness of the bracket 4, and part or all of the thickness of the first and/or second profile 9a, 10a, 11a, 12a.

In practice, the additional laser-welded joint 15 rigidly secures the bracket 4 to the first and second profiles 9a, 10a, 11a, 12a, structurally unifying them and reinforcing the mechanical joint 5.

The door/window fixture 1, as described above, is produced through a process involving several steps.

Initially, the mechanical bracket 4 is inserted into adjacent grooves 9b, 9c, 10b, 11b, 11c, 12b of the two contiguous profiles 9a, 10a, 11a, 12a, but is not yet rigidly fixed, forming an assembly.

Specifically, each arm of the bracket 4 is inserted into a corresponding groove 9b, 9c, 10b, 11b, 11c, 12b of one of the two contiguous profiles 9a, 10a, 11a, 12a.

Some grooves, particularly 9b, 9c, 10b, 11c, may have an open longitudinal side, while others, such as 11b, 12b, have closed longitudinal sides.

“Longitudinal side” refers to a side extending along the main direction of the profiles 9a, 10a, 11a, 12a.

Subsequently, the assembly, typically comprising four profiles 9a, 10a, 11a, 12a forming a frame 9, 10, 11, 12 and spaced apart and held in position by four brackets 4, is precisely positioned on a workbench, and the relative position between each first and second profile 9a, 10a, 11a, 12a and each bracket 4 interposed between a pair of profiles 9a, 10a, 11a, 12a is registered.

This step also includes leveling the visible surfaces of the profiles 9a, 10a, 11a, 12a so that, at the perimeter 8, the two profiles 9a, 10a, 11a, 12a facing said perimeter 8 are flush with one another, thereby avoiding unpleasant and undesirable steps or misalignments.

The handling of the profiles 9a, 10a, 11a, 12a can be carried out by a multi-axis robot, which positions the profiles 9a, 10a, 11a, 12a against dedicated reference elements on a prepared work surface.

At this point, the first and second profiles 9a, 10a, 11a, 12a and the joining bracket 4 are locked in the registered position; once this operation has been carried out for all four corners of the frame 9, 10, 11, 12, the welding process can begin.

The locking is carried out by means of a clamp that secures the profiles 9a, 10a, 11a, 12a of the frame 9, 10, 11, 12 to the workbench; alternatively, the clamp may also be integrated into the robot itself.

The first and/or second additional laser-welded joints 14, 15 are then executed.

Specifically, both the first and the second additional laser-welded joints 14, 15 are performed, regardless of the order, at each of the four corners of the frame 9, 10, 11, 12.

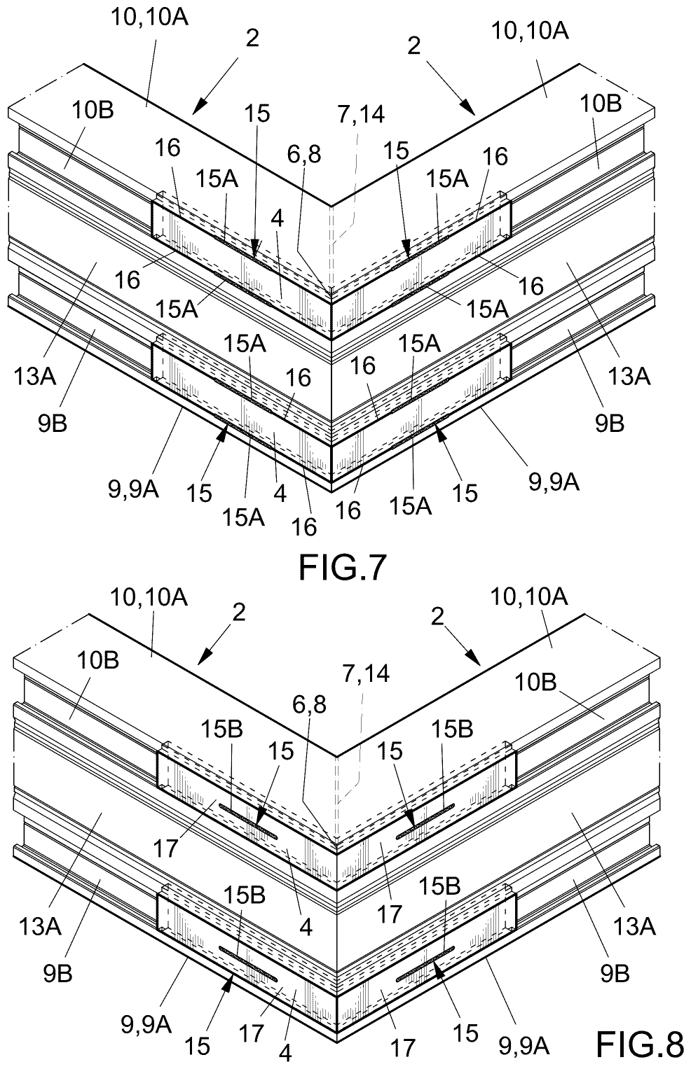

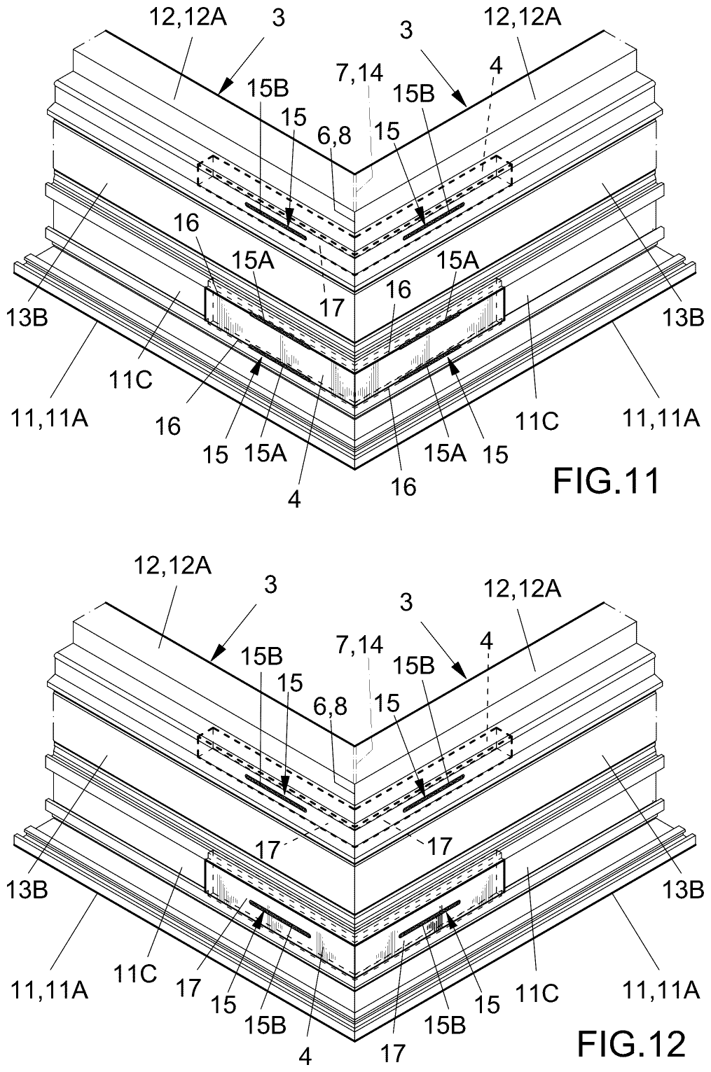

For brackets 4 inserted into grooves 9b, 9c, 10b, 11c, which have an open longitudinal side, the second additional laser-welded joint 15 may be performed either along one or more perimeter edges 16 of the bracket 4 (see FIGS. 7 and 11), or in a recessed position 17 from the perimeter edges (FIGS. 8, 9, and 12), however, for brackets 4 inserted into grooves 11b, 12b, which have all longitudinal sides closed, the second laser-welded joint 15 can only be made in the recessed position 17 from the perimeter edges 16 of the bracket 4 (FIGS. 11, 12, and 14), through the thickness of one of the closed longitudinal sides.

The first and the second additional laser-welded joint 14, 15 are performed using a laser emitter and a system for moving and aiming the laser beam.

The laser beam movement and targeting system may comprise, for example, a movable welding head or movable mirrors capable of directing the laser beam where required.

The laser beam movement and targeting system is configured to move the laser beam at high speed around and within the frame 9, 10, 11, 12, reaching all the points that require welding.

The movement of the laser beam alone, by means of the laser beam movement and targeting system, instead of moving the entire frame 9, 10, 11, 12, allows for a drastic reduction in the manufacturing time thereof, since, as mentioned, the frame remains stationary while only the laser beam moves at high speed.

Additionally, multiple laser emitters and beam control systems may be used simultaneously on the same frame 9, 10, 11, 12, further reducing welding time.

Advantageously, four laser emitters and four laser beam movement systems may be used, each working on one of the four corners of the frame 9, 10, 11, 12.

The four laser emitters and the four laser beam movement and targeting systems may perform the welding simultaneously at all four corners of the frame 9, 10, 11, 12, thereby preventing the internal stresses of frame 9, 10, 11, 12 from concentrating at a single corner of the frame 9, 10, 11, 12, which might otherwise occur in the case of sequential welding at the corners of the frame 9, 10, 11, 12.

The door/window fixture according to the invention is particularly advantageous as it allows for a greater consolidation of the joint between two contiguous profiles, which is now ensured not only by the welding between the brackets and the profiles, but also by the welding directly between the profiles themselves.

As a result, the frame is mechanically stronger and more durable over time.

Moreover, in addition to reinforcing the connection, the laser welding between the two profiles makes it possible to eliminate the mechanical connection line between the contiguous profiles by covering it, thereby removing what is typically an anesthetic perimeter joint.

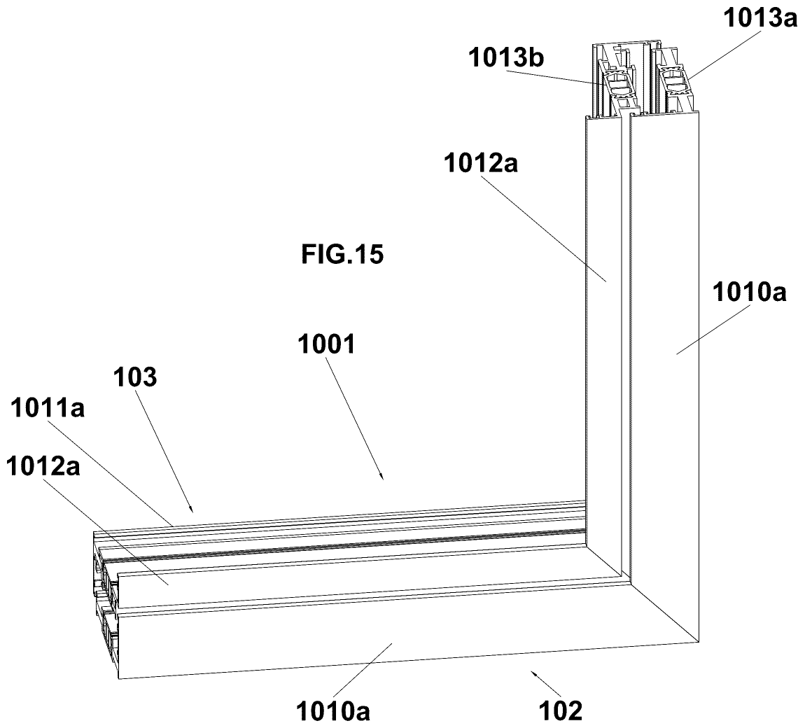

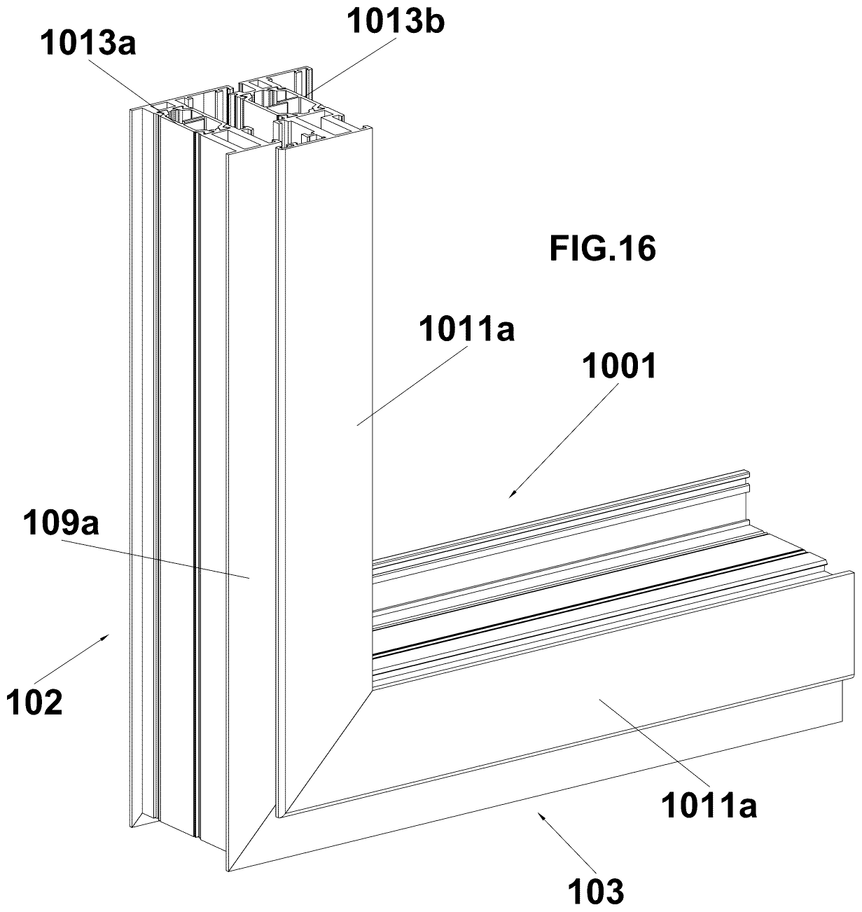

With reference to FIGS. 15-18, an angle of a thermal break door/window fixture is shown, indicated overall by reference numeral 1001.

Equivalent elements across various embodiments of the invention are designated with the same reference numbers.

The thermal break door/window frame 101 includes a fixed frame 102 and a movable frame 103.

The fixed frame 102 is formed by a series of profiles 1009a, 1010a and a series of angular joints that successively connect adjacent profiles 1009a, 1010a to form a frame that defines a seat for the movable frame 103.

Likewise, the movable frame 103, comprising one or more sashes, is made of a series of profiles 1011a, 1012a, and corner joints connecting adjacent profiles to form one or more frames defining compartments for infill panels, typically made of glass.

Specifically, the fixed frame 102 comprises an inner metal fixed frame 1009 formed by profiles 1009a connected by a first set of corner joints 100′, 100″, and an outer metal fixed frame 1010 formed by profiles 1010a connected by a second set of corner joints 101′, 101″ and the movable frame 103 comprises an inner metal movable frame 1011 formed by profiles 1011a connected by a third set of corner joints 102′, 102″, and an outer metal movable frame 1012 formed by profiles 1012a connected by a fourth set of corner joints 103′, 103″.

Preferably, all metal profiles 1009a, 1010a of the fixed frame 102 and all metal profiles 1011a, 1012a of the movable frame are made of aluminum or aluminum alloy.

In particular, the aluminum alloy used for profiles 1009a, 1010a, 1011a, 1012a is an aluminum, silicon and magnesium alloy.

Even more specifically, the profiles 1009a, 1010a, 1011a, 1012a are made of aluminum alloy 6005 or 6060.

The fixed frame 102 features a thermal break that separates the inner frame 1009 from the outer frame 1010, and the movable frame 103 features a thermal break separating the inner frame 1011 from the outer frame 1012.

The thermal break in the fixed frame 102 consists of non-metallic, thermally insulating profiles 1013A, and the thermal break in the movable frame 103 consists of non-metallic, thermally insulating profiles 1013B.

Each frame 1009, 1010, 1011, 1012 is specifically formed by a quadrangular frame composed of four profiles 1009a, 1010a, 1011a, 1012a, two of which are horizontal and two are vertical, joined at 90° to the two horizontal profiles.

At each of its four corners, each frame 1009, 1010, 1011, 1012 thus includes an angular joint between a first profile 1009a, 1010a, 1011a, 1012a and a second profile 1009a, 1010a, 1011a, 1012a adjacent to the first profile 1009a, 1010a, 1011a, 1012a.

Advantageously, each corner joint of at least one of the first, second, third, and fourth sets of corner joints 100′, 100″, 101′, 101″, 102′, 102″, 103′, 103″ includes at least one laser weld joint between thickened walls 104a, 104b, 105a, 105b, 106a, 106b, 107a, 107b of the profiles 1009a, 1010a, 1011a, 1012a, which extend orthogonally to the exposed walls 108, 109, 110, 111 of the profiles 1009a, 1010a, 1011a, 1012a.

The exposed walls 108, 109, 110, 111 of the profiles 1009a, 1010a, 1011a, 1012a are the flat vertical walls of the profiles 1009a, 1010a, 1011a, 1012a that are farthest from the thermal break profiles 1013A, 1013B.

On the inner side of the frame, the exposed wall 110 of the profile 1011a partially overlaps the exposed wall 108 of the profile 1009a, whereas on the outer side of the frame, the exposed wall 111 of the profile 1012a and the exposed wall 109 of the profile 1010a are aligned on the same vertical plane.

Advantageously, the thickened walls 104a, 104b, 105a, 105b, 106a, 106b, 107a, 107b of the profiles 1009a, 1010a, 1011a, 1012a have a minimum thickness between 2 and 3 times the minimum thickness of the exposed walls 108, 109, 110, 111 of the profiles 1009a, 1010a, 1011a, 1012a.

Generally, the exposed walls 108, 109, 110, 111 of the profiles 1009a, 1010a, 1011a, 1012a have a constant thickness along their entire length. However, in some cases, they may have a reduced, thus minimum, thickness at the locations formed on their non-visible side to accommodate seals 112, 113, 114, in particular an internal seal 112 for sealing between the fixed frame 102 and the movable frame 103, an external seal 113 for sealing between the fixed frame 102 and the movable frame 103, and a seal 114 for sealing with the glass infill.

The first series of corner joints 100′, 100″ may include a laser weld 100′ executed on the side of the thickened walls 104a of the profiles 1009a of the inner metal fixed frame 1009 facing toward the movable frame 103, and/or a laser weld 100″ performed on the opposite side of the same walls 104a, or on the side of other thickened walls 104b of the profiles 1009a, opposite the movable frame 103.

The second set of corner joints 101′, 101″ may include a laser weld joint 101′ made on the side of the thickened walls 105a of the profiles 1010a of the external metallic fixed frame 1010 facing the movable frame 103 and/or a laser weld joint 101″ made on the opposite side of the same walls 105a or on the side of other thickened walls 105b of the profiles 1010a of the external metallic fixed frame 1010 opposite the movable frame 103.

The third set of corner joints 102′, 102″ may include a laser weld joint 102′ made on the side of the thickened walls 106a of the profiles 1011a of the internal metallic movable frame 1011 opposite the fixed frame 102 and/or a laser weld joint 102″ made on the opposite side of the same walls 106a or on the side of other thickened walls 106b of the profiles 1011a of the internal metallic movable frame 1011 facing the movable frame 103.

The fourth set of corner joints 103′, 103″ may include a laser weld joint 103′ made on the side of the first thickened walls 107a of the profiles 1012a of the external metallic movable frame 1012 opposite the fixed frame 102 and/or a laser weld joint 103″ made on the side of the second thickened walls 107b of the profiles 1012a of the external metallic movable frame 1012 facing the fixed frame 102.

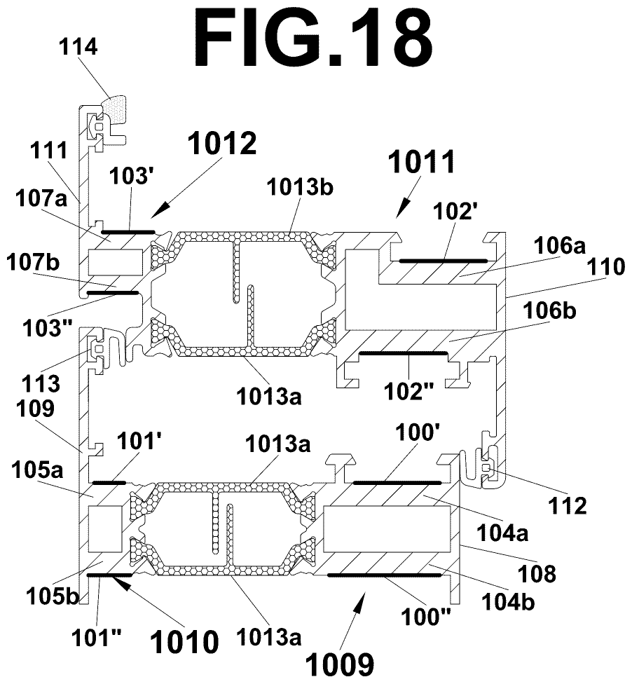

It should be noted that, advantageously, in order to allow laser welding to be carried out from one of the opposite sides of the profiles 1009a, 1010a, 1011a, 1012a, or from both opposite sides, two thickened walls 104a and 104b, 105a and 105b, 106a and 106b, 107a and 107b may be provided, spaced apart from each other, as clearly shown in FIG. 18.

However, it is generally preferable to perform the laser weld on only one side of the opposite profiles 1009a, 1010a, 1011a, 1012a to ensure adequate structural strength.

Therefore, it is preferable that one of the laser joints 100′ and 100″, one of the laser joints 101′ and 101″, one of the laser joints 102′ and 102″, and one of the laser joints 103′ and 103″ be present as alternatives.

The corner joints 100′, 100″, 101′, 101″, 102′, 102″, 103′, 103″ are typically butt joints between flat ends cut at 45° of the adjacent profiles 1009a, 1009a, 1010a, 1010a, 1011a, 1011a, 1012a, 1012a.

Generally, it has been found advantageous, in order to achieve adequate structural strength of the frame without the need for mechanical joints, to use profiles 1009a, 1010a, 1011a, 1012a made entirely of aluminum alloy 6005 or entirely of aluminum alloy 6060, wherein, with the exposed walls 108, 109, 110, 111 of the profiles 1009a, 1010a, 1011a, 1012a having a minimum thickness between 1.5 mm and 2.0 mm, the thickened walls 104a, 104b, 105a, 105b, 106a, 106b, 107a, 107b of the profiles 1009a, 1010a, 1011a, 1012a have a minimum thickness between 3.0 mm and 6.0 mm.

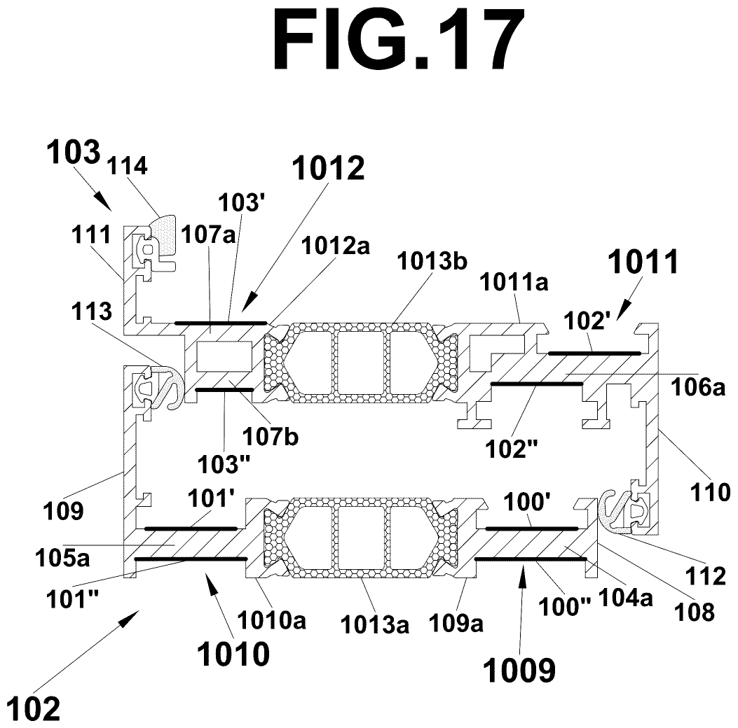

FIG. 17 shows, by way of example, a minimal thermal break frame in aluminum alloy 6005, with a visible width between 50 mm and 65 mm.

In this case the visible walls 108, 109, 110, 111 of the profiles 1009a, 1010a, 1011a, 1012a have a minimum thickness of 1.8 mm, the thickened walls 104a, 105a, 106a of the profiles 1009a, 1010a, 1011a have a minimum thickness of 5.0 mm, the thickened walls 107a, 107b of the profiles 1012a have a minimum thickness of 4.0 mm.

FIG. 18 shows, by way of example, a non-minimal thermal break frame in aluminum alloy 6060, with a visible width between 80 mm and 90 mm.

In this case, the exposed walls 108, 109, 110, 111 of the profiles 1009a, 1010a, 1011a, 1012a have a minimum thickness of 1.6 mm; the thickened walls 104a, 104b, 105a, 105b, 106a, 106b of the profiles 1009a, 1010a, 1011a have a minimum thickness of 5.0 mm; and the thickened walls 107a, 107b of the profiles 1012a have a minimum thickness of 4.0 mm.

While laser welds provide sufficient structural strength, they may optionally be complemented by other types of joints, such as mechanical joints using brackets inserted into appropriate internal grooves of the adjacent profiles 1009a, 1010a, 1011a, 1012a.

These brackets may be useful for aligning the adjacent profiles 1009a, 1010a, 1011a, 1012a and may contribute to the overall strength of the joint of adjacent profiles 1009a, 1010a, 1011a, 1012a.

The door/window fixture 100, as described above, is manufactured through a process consisting of several steps.

The operation is carried out in a similar manner for the construction of both the fixed frame and the movable frame.

Initially, brackets are inserted into the adjacent profiles.

Then, the assembly, formed by the profiles of the frame, is positioned on a workbench, and the positions of the profiles are registered.

The profiles may be manipulated using a multi-axis robot, which places them against specific reference stops on the work surface.

Once the profiles are positioned, they are clamped in the registered positions; after repeating this operation for all four corners of the frame, the welding process can begin.

The clamping is performed using a vise that secures the profiles to the workbench; the vise may also be integrated into the robot.

Laser welding is then carried out using a laser emitter and a system for moving and aiming the laser beam.

The laser beam movement and aiming system may comprise, for example, a movable welding head or movable mirrors capable of directing the laser beam where needed.

The laser beam movement and aiming system is configured to move the laser beam at high speed within the frame, reaching all points that require welding.

The movement of only the laser beam by means of the laser beam movement and aiming system, instead of moving the entire frame, allows for a significant reduction in production time, since, as mentioned, the frame remains stationary while only the laser beam moves at high speed.

Moreover, multiple laser emitters and multiple laser beam movement and aiming systems may also be provided, capable of operating simultaneously on the same frame, thereby allowing the welding time to be further reduced.

Advantageously, four laser emitters and four laser beam movement and aiming systems may be provided, each operating at one of the four corners of the frame.

The four laser emitters and the four laser beam movement and aiming systems can perform the welding simultaneously at all four corners of the frame, thereby avoiding the concentration of internal stresses in only one corner of the frame, which could otherwise occur in the case of sequential welding at the frame corners.

The door/window fixture according to the invention offers enhanced mechanical strength and greater long-term durability.

The design described here is susceptible to numerous modifications and variations, all of which fall within the scope of the inventive concept.

For example, the inventive concept includes a door/window fixture where one or more laser welds are performed without filler material, a door/window fixture where one or more laser welds are performed with filler material, such as aluminum alloys, for instance alloy 5356 or alloy 4047, though not limited to these.

Also within the scope of the inventive concept is a door/window fixture without thermal break, a door/window fixture without glass infill, a door/window fixture having a fixed frame and a movable frame with a non-quadrangular configuration, a metal door/window fixture made of a material other than aluminum or in which only one of the fixed frame or the movable frame is made of aluminum or an aluminum alloy, a door/window fixture with non-butt mechanical joints where profiles with ends cut at 90° are used, or a door/window fixture in which not all, and possibly only one, of the mechanical joints between contiguous profiles includes laser welding.

The inventive concept also encompasses the frame of a mosquito screen, and more generally, the mosquito screen itself.

The mosquito screen frame therefore comprises at least one mechanical joint between a first metal profile and a second metal profile, wherein the mechanical joint includes a metal joining bracket, and wherein the material of the two profiles and the bracket is identical, specifically selected from aluminum or an aluminum alloy.

1. A fixture comprising for a door or a window, the fixture comprising a fixed frame and a movable frame, wherein at least one of the fixed frame and the movable frame includes at least one mechanical joint between a first profile and a second profile, said mechanical joint including a joining bracket, the fixture further comprising a first additional laser-welded joint between said first and second profiles and a second additional laser-welded joint between at least one of said first and second profiles and said joining bracket, and in that said first profile, said second profile, and said joining bracket are made from the same metal material selected from aluminum or aluminum alloy.

2. The fixture according to claim 1, wherein the mechanical joint defines an interface surface between said mechanically joined first and second profiles, and in that the first additional laser-welded joint includes a laser weld line between said mechanically joined first and second profiles, said laser weld line extending along at least a portion of the perimeter of said interface surface.

3. The fixture according to claim 1, wherein said mechanically joined first and second profiles comprise two mechanically joined profiles of said fixed frame.

4. The fixture according to claim 1, wherein said mechanically joined first and second profiles comprise two mechanically joined profiles of said movable frame.

5. The fixture according to claim 1, wherein the second additional laser-welded joint between at least one of said first and second profiles and said joining bracket comprises laser weld lines extending along one or more perimeter edges of said joining bracket.

6. The fixture according to claim 1, wherein the second additional laser-welded joint between at least one of said first and second profiles and said joining bracket comprises laser weld lines extending in a recessed position from the perimeter edges of said joining bracket, and extending through a portion or the entire thickness of the joining bracket and a portion or the entire thickness of said first and second profiles.

7. A frame for a window or door, the frame comprising a fixed frame and a movable frame, wherein the fixed frame comprises an inner metal fixed frame formed by inner fixed frame profiles connected via a first set of corner joints, and an outer metal fixed frame formed by outer fixed frame profiles connected via a second set of corner joints, and wherein the movable frame comprises an inner metal movable frame formed by inner movable frame profiles connected via a third set of corner joints, and an outer metal movable frame formed by outer movable frame profiles connected via a fourth set of corner joints, wherein each corner joint of said first, second, third, and fourth sets of corner joints includes at least one laser weld between thickened walls of said metal profiles of the fixed frame and movable frame that extend orthogonally to exposed walls of said metal profiles of the fixed frame and the movable frame, said thickened walls having a minimum thickness between 2 and 3 times a minimum thickness of said exposed walls of said metal profiles of the fixed frame and the movable frame.

8. The frame according to claim 7, wherein all corner joints between said metal profiles of the fixed frame and movable frame consist exclusively of laser welds between said thickened walls.

9. The frame according to claim 7, wherein said metal profiles of the fixed frame and movable frame are made of aluminum alloy 6005 or aluminum alloy 6060.

10. The frame according to claim 9, wherein said the minimum thickness of the exposed walls of the metal profiles of the fixed frame and movable frame is between 1.5 mm and 2.0 mm, and the minimum thickness of said thickened walls of metal profiles of the fixed frame and the movable frame is between 3.0 mm and 6.0 mm.

11. The frame of claim 7, wherein at least one of said metal profiles of the fixed frame and movable frame comprises two spaced thickened walls.

12. An assembly comprising two metal profiles of a frame for a door or window, said two metal profiles connected by an angular joint, wherein said angular joint includes at least one laser weld between thickened walls of said two metal profiles, which extend orthogonally to exposed walls of said two metal profiles, said thickened walls having a minimum thickness ranging from 2 to 3 times a minimum thickness of the exposed walls of said metal profiles.
